(19) United States
(12) Patent Application Publication
(10) Pub. No.: US 2008/0115191 A1
(43) Pub. Date: May 15, 2008

(54) Method and apparatus to transmit personal information using trustable device

(75) Inventors: Ji-soo Kim, Yongin-si (KR); Myung-june Jung, Suwon-si (KR); Hyun-jin Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/723,067

(22) Filed: Mar. 16, 2007

(30) Foreign Application Priority Data
Nov. 14, 2006 (KR) 2006-112447

(51) Int. Cl. H04L 9/00; G06F 17/00; H04K 1/00; H04L 9/32; G06K 9/00; G06F 17/30; G06F 7/04

(52) U.S. Cl. 726/1; 713/181; 713/173; 713/175; 726/2; 713/182

(57) ABSTRACT

A method and apparatus to transmit personal information, the method including: receiving an information request message requesting the personal information; receiving the personal information from a user; receiving a transmission approval from the user; transmitting a service requesting identifier to the service provider when the transmission approval is received; receiving a security policy with respect to the personal information to be transmitted; securing the personal information to be transmitted according to the received security policy; and transmitting the personal information to the service provider. Therefore, the personal information can be safely transmitted.

### CROSS-REFERENCE TO RELATED APPLICATION

This application claims the benefit of Korean Patent Application No. 2006-112447, filed on Nov. 14, 2006, in the Korean Intellectual Property Office, the disclosure of which is incorporated herein by reference.

### BACKGROUND OF THE INVENTION

1. Field of the Invention

Aspects of the present invention relate to a method and apparatus to transmit personal information, and more particularly, to a method and apparatus to safely transmit a user's personal information, required for a service selected by the user, to a service provider in untrustworthy devices, such as a personal computer (PC).

2. Description of the Related Art

Recently, methods of safely transmitting sensitive information, such as personal information, have been sought. In particular, a trusted path (TP) method has been developed. TP refers to a mechanism providing a firm belief that a user communicates with an intended party. The main problem caused by an absence of a TP is hacking, such as providing a fake logon screen, phishing, and key stroke interception. Due to these hacking techniques, users cannot tell if individual information is transmitted from their own PC to a remote site and cannot confirm the truth of information displayed on a PC.

FIG. 1 is a diagram illustrating a conventional method of transmitting personal information using a PC. Referring to FIG. 1, a user 100 searches for desired products or services by using a web browser of the PC 110. Then, when the user 100 would like to purchase the products or services, the user 100 inputs personal information into the PC 110. The inputted information is encoded using a cryptographic protocol (such as Secure Sockets Layer (SSL) or Transport Layer Security (TLS)) and is transmitted to a service provider through an Internet network 120.

In FIG. 1, the user 100 inputs his/her personal information each time he/she purchases the products or services. In addition, since the PC basically employs a universal protocol based on an open frame, compatibility and expandability thereof are enhanced, but the PC is, as a result, more vulnerable to a virus or hacking. Moreover, when personal information is transmitted to an undesired destination due to a virus or hacking, users are not aware of the problem.

FIG. 2 is a diagram illustrating a conventional method of transmitting personal information using a smart card. Referring to FIG. 2, a user 200 searches for desired products or services by using a web browser on the PC 210. Then, when the user 200 would like to purchase the products or services, a security token 220 such as a smart card or a Subscriber Identification Module (SIM) card is connected to the PC 210. Then, when personal information required for a service is inputted into the PC 210, the inputted personal information is transmitted to the security token 220. The transmitted personal information is encoded by the security token 220, thus protecting the personal information. Then, the protected personal information is transmitted to the PC 210 and is provided to a service provider through an Internet network 230.

In FIG. 2, a message containing the personal information is difficult to forge or alter. However, operations, such as an electronic signature, are performed by an untrustworthy application program of the PC 210 connected to the security token 220. As a result, the user 200 is not sure whether the personal information is accurately transmitted and whether the personal information is provided to the service selected by the user 200. In addition, the security token itself only contains fixed information and a user 200 cannot update information when he/she needs to, thereby reducing flexibility and expandability.

### SUMMARY OF THE INVENTION

Aspects of the present invention provide a method and apparatus to safely transmit a user's personal information required for a service selected by the user to a service provider, in untrustworthy devices such as a personal computer (PC).

According to an aspect of the present invention, there is provided a method of transmitting personal information required by a service or product requested through an external device to a service provider, the method including: receiving an information request message requesting the personal information; receiving the personal information from a user; receiving a transmission approval from the user; transmitting a service requesting identifier to the service provider when the transmission approval is received; receiving a security policy with respect to the personal information to be transmitted; securing the personal information to be transmitted according to the received security policy; and transmitting the personal information to the service provider.

The transmitting of the personal information may further include performing an integrity measurement with respect to a platform of a predetermined device according to the security policy; and transmitting an attestation certificate obtained after the integrity measurement.

According to another aspect of the present invention, there is provided a computer-readable medium having recorded thereon a computer program to execute the method described above.

According to another aspect of the present invention, there is provided an apparatus to transmit personal information required by a service or product requested through an external device to a service provider, the apparatus including: a personal information storage unit to store personal information of a user; a user interface (UI) to display an information request message requesting the personal information and to receive inputs and selections of the personal information to be transmitted from among the personal information stored in the personal information storage unit; a security policy determination unit to transmit a service requesting identifier to the service provider and to receive a security policy for the personal information to be transmitted; and an encoding unit to encode the personal information to be transmitted according to the received security policy and to provide the encoded personal information to the service provider.

The apparatus may further include an integrity measurement unit to perform an integrity measurement with respect to a platform of the device and to transmit an attestation certificate with respect to the integrity measurement to the service provider.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional method of transmitting personal information using a personal computer (PC);

FIG. 2 is a diagram illustrating a conventional method of transmitting personal information using a smart card;

FIG. 3 is a diagram of a system for transmitting personal information using a personal data assistant (PDA) according to an embodiment of the present invention;

FIG. 4 is a diagram of a system for transmitting personal information using a PDA according to another embodiment of the present invention;

FIG. 5 is a diagram illustrating components of the system including the PDA illustrated in FIG. 3, according to an embodiment of the present invention;

FIG. 6 is a flow chart illustrating a process of obtaining a final transmission approval from a user with respect to personal information to be transmitted from a PDA, according to an embodiment of the present invention;

FIG. 7 is a diagram illustrating a process of transmitting personal information from a PDA to a service provider, according to an embodiment of the present invention; and

FIG. 8 illustrates a message transmitted to a service provider from a PDA, according to an embodiment of the present invention.

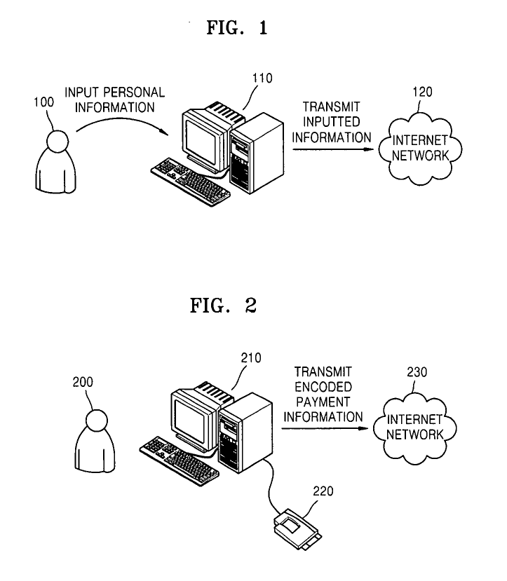

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

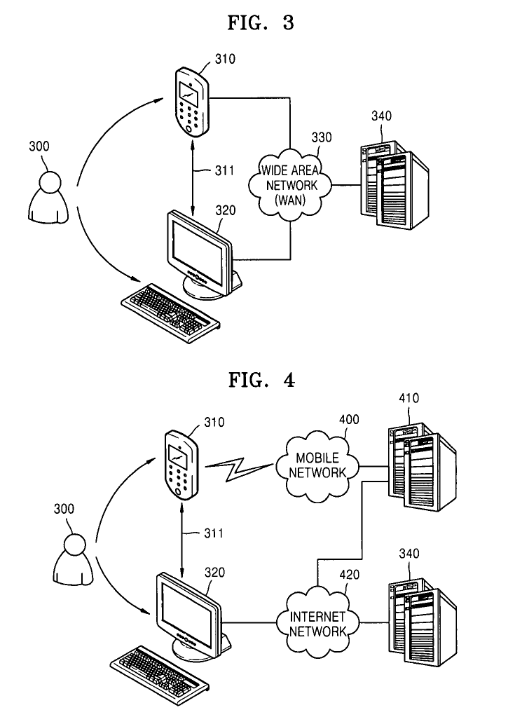

FIG. 3 is a diagram of a system to transmit personal information using a personal data assistant (PDA) according to an embodiment of the present invention. In this specification, the PDA is an example of a trustable device, and a personal computer (PC) is an example of an untrustworthy device. However, it is understood that the PDA and the PC are not the only examples of trustable and untrustworthy devices. The untrustworthy device is a device based on an open platform in which integrity attestation cannot be performed. Meanwhile, the trustable device stores a user's personal information and is based on a closed platform or employs technology for trusted computing, thereby enabling integrity attestation of the platform. In general, the untrustworthy device is vulnerable to a virus or hacking and the trustable device is more protected than the untrustworthy device with respect to a virus or hacking. The platform is a basic system in which an application program can be executed.

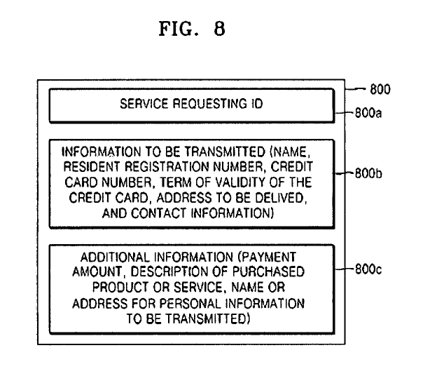

Referring to FIG. 3, a user 300 searches for a required service or product by using a web browser of a PC 320. Then, when the user 300 wants to purchase the service or product, a message requesting information about the service or product is transmitted to a PDA 310. It is understood that aspects of the present invention are not limited to the requesting of a service or product from an untrustworthy device. For example, the service or product request can be made from a trustable device, such as the PDA 310. Furthermore, it is understood that aspects of the present invention may be applied to any transmission of data through a wired or wireless network, and not necessarily for the purpose of requesting a product or service. Moreover, the service or product as referred to throughout this specification is anything physical or non-physical that requires a user's personal information in order to attain. The service or product is provided by a service provider 340. An example of the message requesting information is as illustrated in FIG. 8. The message requesting information 800 is created in the PC 320, as illustrated in FIG. 3. However, the message requesting information 800 can also be created by the service provider 340 and transmitted therefrom. Then the message requesting information 800 is displayed in the PDA 310 for the user 300. Next, the user 300 selects the required information 800b from personal information previously stored in the PDA 310 and approves a transmission. However, the message 800 and the personal information 800b are not sent yet. Furthermore, it is understood that, according to other aspects of the present invention, the user 300 may also enter the required information manually.

Then, the PDA 310 transmits a service requesting identifier to the service provider 340 through a wide area network (WAN) 330. The service provider 340 determines whether the service indicated by the received service requesting identifier is the service requested by the user 300. If the service is requested by the user 300, a security policy for the personal information is transmitted to the PDA 310. The PDA 310, which receives the security policy, encodes the personal information 800b according to an encoding method included in the security policy, and transmits the encoded personal information 800b to the service provider 340.

The personal information 800b includes private information of a user, such as a name, a resident registration number, a credit card number, a term of validity (expiration date) of the credit card, and mobile phone number. The displayed and encoded personal information may also include product and service related information, such as a purchased product, a payment amount for the service, a description, and an address to which the purchased product is to be delivered.

In addition, the security policy transmitted by the service provider 340 may further include a method of encoding the personal information 800b, a method of protecting the personal information 800b such as a digital signature, and information on the integrity attestation. The integrity attestation is a process of securing the accuracy of the information. In other words, the service provider 340 may further include information on whether the integrity attestation should be carried out in addition to the security policy to be transmitted. If the integrity attestation should be carried out, the PDA 310 measures the integrity attestation with respect to the platform included. Then the result measured is contained in an attestation certificate that is to be transmitted to the service provider 340. Next, the service provider 340 inspects the received attestation certificate and determines whether communication with the PDA 310 should be continued according to the result of inspection.

Any trustable device and untrustworthy device that can transmit data through a wired/wireless communications connection 311 (such as a local area network (LAN), a WAN, Bluetooth, or Infrared Data Association (IrDA)) can be used.

FIG. 4 is a diagram of a system to transmit personal information using the PDA 310 according to another embodiment of the present invention. Here, a mobile network 400 is used. The mobile network 400, a mobile network service provider 410, and an Internet network 420 can be included in the WAN 330 illustrated in FIG. 3. In particular, the mobile network service provider 410 provides a mobile network service to the PDA 310 and can be connected to the service provider 340 through the Internet network 420.

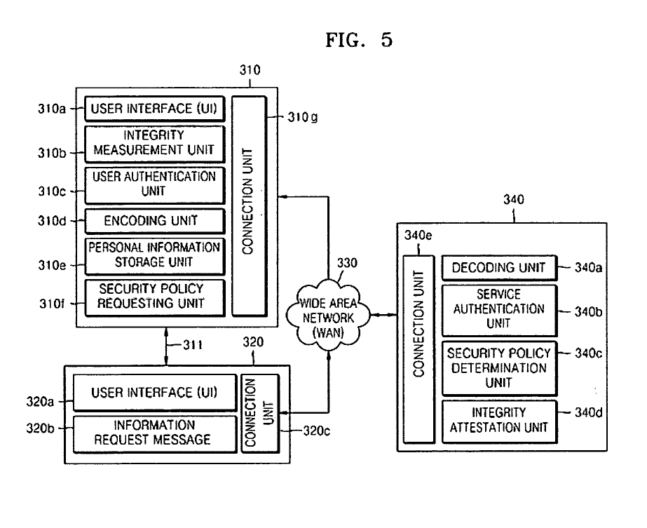

FIG. 5 is a diagram illustrating components of the system including the PDA 310 illustrated in FIG. 3, according to an embodiment of the present invention. Referring to FIG. 5, the PDA 310 includes a user interface (UI) 310a, an integrity measurement unit 310b, a user authentication unit 310c, an encoding unit 310d, a personal information storage unit 310e, a security policy requesting unit 310f, and a connection unit 310g. The PC 320 includes a UI 320a, an information request message generation unit 320b, and a connection unit 320c. In addition, the service provider 340 includes a decoding unit 340a, a service authentication unit 340b, a security policy determination unit 340c, an integrity attestation unit 340d, and a connection unit 340e. However, it is understood that according to other aspects of the present invention, the trustable device, untrustworthy device, and service provider 340 may include more or less components. For example, the service provider 340 may also include an information request message generation unit.

The UI 310a of the PDA 310 displays an information request message 800 including personal information 800b required for a service selected by a user 300 received from the PC 320. The personal information 800b inputted or selected by the user 300 from, for example, among the personal information stored in the personal information storage unit 310e is inputted into the PDA 310.

The integrity measurement unit 310b performs integrity measurement with respect to the platform of the PDA 310 according to the security policy and transmits the attestation certificate with respect to the integrity measurement to the service provider 340.

The user authentication unit 310c authenticates the user 300 while confirming, deleting, renewing, or transmitting the personal information stored in the PDA 310. For example, the user authentication unit 310c authenticates whether the user 300 is valid using a method of requesting a password from the user 300 by means of the UI 310a. Therefore, the password previously set by the user 300 should be stored in the personal information storage unit 310e.

The encoding unit 310d encodes the personal information 800b inputted or selected by the user 300 from among the personal information stored in the PDA 310 according to the security policy received from the service provider 340, in order for the personal information 800b to be transmitted to the service provider 340.

In addition, while the encoded personal information 800b is transmitting to the service provider 340, the user 300 can be informed about a current transmitting state by the use of the UI 310a. For example, flashing a predetermined light on the PDA 310 or a signal tone can be used.

The personal information storage unit 310e stores the personal information of the user. It is understood that, according to other aspects of the present invention, the personal information storage unit 310e is not included in the trustable device, and the personal information is entered manually.

When a transmission approval is given by the user 300, the security policy requesting unit 310f provides the service requesting identifier to the service provider 340, requests the security policy, and receives the security policy according to the request.

The connection unit 310g is a module for connecting with the WAN 330 or the PC 320. Data is inputted into the PDA 310 or outputted from the PDA 310 through this module.

The UI 320a of the PC 320 searches for the service requested by the user 300 through a web browser.

The information request message generation unit 320b includes information required for the service, the service requesting identifier 800a, the required personal information of the user 800b, and the additional information 800c, as illustrated in FIG. 8. The information request message 800 may be generated from the PC 320 or provided additionally by the service provider 340, according to an embodiment of the present invention.

The connection unit 320c is a module for connecting with the WAN 330 or the PC 320. Data is inputted into the PC 320 or outputted from the PC 320 through this module.

The decoding unit 340a of the service provider 340 decodes the encoded personal information 800b transmitted from the PDA 310.

The service authentication unit 340b receives the service requesting identifier from the PDA 310 and confirms whether the received service requesting identifier is the service registered in the service authentication unit 340b to transmit a transmission approval message.

The security policy determination unit 340c determines a method of protecting the personal information 800b, for example, a method of encoding the personal information 800b and a digital signature method, and determines whether the integrity measurement should be performed with respect to the platform of the PDA 310, according to an embodiment of the present invention.

The integrity attestation unit 340d inspects the integrity certificate transmitted from the PDA 310 and thus identifies whether the PDA 310 is trustable.

The connection unit 340e is a module for connecting with the WAN 330. Data is inputted into the service provider 340 or outputted from the service provider 340 through this module.

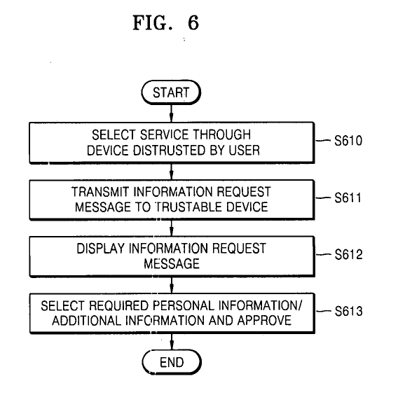

FIG. 6 is a flow chart illustrating a process of obtaining a final transmission approval from a user 300 with respect to the personal information 800b to be transmitted from the PDA 310, according to an embodiment of the present invention. Referring to FIG. 6, a user 300 selects the required service by using the UI 320a in operation s610. Then, an information request message 800 is transmitted to the PDA 310 in operation s611. The transmitted message 800 is displayed by the UI 310a of the PDA 310 in operation s612. Then, in operation s613, the user selects required personal information or additional information by using the UI 310a and approves a final transmission.

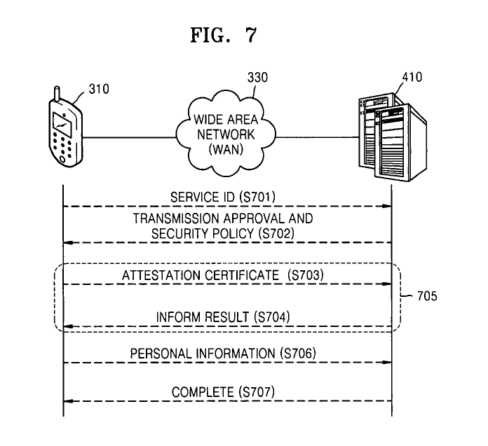

FIG. 7 is a diagram illustrating a process of transmitting personal information from the PDA 310 to the service provider 340, according to an embodiment of the present invention. Referring to FIG. 7, the PDA 310 provides the service requesting identifier corresponding to the service or product requested by the user 300 to the service provider 340, in operation s701.

In operation s702, the service provider 340 confirms whether the service is registered in or provided by the service provider 340 using the service requesting identifier. When it is confirmed that the service is registered in or provided by the service provider 340, a transmission approval message and the security policy for the personal information are transmitted by the mobile network service provider 410. The PDA 310 encodes the personal information 800b according to the encoding method included in the security policy and transmits the personal information 800b encoded in operation s706 to the service provider 340. Then, in operation s707, the entire process is completed.

According to an embodiment of the present invention, the integrity attestation procedures illustrated in operation s705 may be further included. In this case, the integrity measurement with respect to the security policy transmitted to the PDA 310 in operation 702 is included.

Therefore, in operation s705, the PDA 310 performs the integrity measurement with respect to the platform included in the PDA 310, and transmits the attestation certificate as a result to the service provider 340 (s703).

In operation s704, since the received attestation certificate is inspected, it is determined whether to continue the communication with the PDA 310. When the inspection is successful, an inspection succeeded message is transmitted and when the inspection fails, a service rejection message is transmitted.

FIG. 8 illustrates a message 800 transmitted to the service provider 340 from the PDA 310, according to an embodiment of the present invention. As illustrated in FIG. 8, the message 800 includes a service requesting identifier 800a, personal information 800b, and additional information 800c. The personal information 800b includes private information of a user, such as a name, a resident registration number, a credit card number, a term of validity of the credit card, and a mobile phone number. The additional information 800c includes product and service related information, such as the name of a purchased product, a payment amount for the service, a description, and an address to which the purchased product is to be delivered. The message 800 may be generated by the service provider 340 or the PC 320 and may be defined in various ways.

According to an aspect of the present invention, the personal information 800b required for the service requested by a user is stored in the PDA 310 in advance and only required personal information can be selected. Thus, the personal information 800b does not have to be inputted each time it is needed with respect to a plurality of services.

In addition, the personal information 800b is transmitted through a trustable device such as the PDA 310. Thus, the personal information 800b can be transmitted in a safer manner than compared to a transmission from the PC 320.

A program for transmitting personal information according to aspects of the present invention can be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave including a compression source code segment and an encryption source code segment (such as data transmission through the Internet). The computer-readable recording medium can also be distributed over network coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of transmitting personal information required by a service or product requested through an external device to a service provider, the method comprising:
receiving an information request message requesting the personal information;
receiving the personal information from a user;
receiving a transmission approval from the user;
transmitting a service requesting identifier to the service provider when the transmission approval is received;
receiving a security policy with respect to the personal information to be transmitted;
securing the personal information to be transmitted according to the received security policy; and
transmitting the personal information to the service provider.

2. The method as claimed in claim 1, wherein the securing of the personal information comprises:
measuring an integrity attestation with respect to a platform of a device that transmits the personal information; and
transmitting an attestation certificate obtained from the measuring of the integrity attestation.

3. The method as claimed in claim 2, wherein the receiving of the security policy comprises:
receiving a request for the measuring of the integrity attestation.

4. The method as claimed in claim 1, further comprising:
receiving a message indicating that the transmitting of the personal information is completed.

5. The method as claimed in claim 1, wherein the transmitting of the personal information comprises:
indicating that the personal information is being transmitted during the transmitting of the personal information.

6. The method as claimed in claim 1, further comprising:
authenticating the user before the transmitting of the personal information.

7. The method as claimed in claim 1, wherein the receiving of the personal information comprises:
storing new personal information that has not previously been stored in a device that transmits the personal information.

8. The method as claimed in claim 1, wherein the receiving of the personal information comprises receiving selections of the personal information from among personal information stored in a device that transmits the personal information.

9. The method as claimed in claim 1, wherein the security policy comprises a method of encoding the personal information, a method of protecting personal information including a digital signature, and/or information on an integrity attestation with respect to a platform of a device that transmits the personal information.

10. The method as claimed in claim 1, wherein the personal information is stored in a predetermined device that transmits the information and is different from the external device.

11. The method as claimed in claim 10, wherein the predetermined device is based on a closed platform or employs technology for trusted computing, thereby enabling an integrity attestation of the platform, and the external device is based on an open platform and cannot perform the integrity attestation.

12. The method as claimed in claim 1, wherein the external device receives the information request, receives the personal information, transmits the service requesting identifier, receives the security policy, secures the personal information, and transmits the personal information.

13. The method as claimed in claim 1, wherein a predetermined device different from the external device receives the information request, receives the personal information, transmits the service requesting identifier, receives the security policy, secures the personal information, and transmits the personal information.

14. The method as claimed in claim 1, wherein the personal information comprises the personal information of the user, additional information, and the service requesting identifier.

15. The method as claimed in claim 1, wherein the information request message includes the service requesting identifier.

16. The method as claimed in claim 1, wherein the securing of the personal information comprises:
encoding the personal information according to the security policy.

17. A computer-readable recording medium encoded with the method of claim 1 and implemented by a computer.

18. An apparatus to transmit personal information required by a service or product requested through an external device to a service provider, the apparatus comprising:
a personal information storage unit to store personal information of a user;
a user interface to display an information request message requesting the personal information and to receive inputs and selections of the personal information to be transmitted from among the personal information stored in the personal information storage unit;
a security policy determination unit to transmit a service requesting identifier to the service provider and to receive a security policy for the personal information to be transmitted; and
an encoding unit to encode the personal information to be transmitted according to the received security policy and to transmit the encoded personal information to the service provider.

19. The apparatus as claimed in claim 18, further comprising:
an integrity measurement unit to measure an integrity attestation with respect to a platform of the apparatus and to transmit an attestation certificate with respect to the integrity attestation to the service provider.

20. The apparatus as claimed in claim 19, wherein the security policy determination unit receives a request for the attestation certificate.

21. The apparatus as claimed in claim 18, wherein the user interface receives and displays a message indicating that a transmission of the personal information is completed.

22. The apparatus as claimed in claim 18, wherein the user interface indicates that the personal information is being transmitted during a transmission of the personal information.

23. The apparatus as claimed in claim 18, wherein the device further comprises
a user authentication unit to authenticate the user before transmitting the personal information.

24. The apparatus as claimed in claim 18, wherein the personal information storage unit stores new personal information that has not previously been stored.

25. The apparatus as claimed in claim 18, wherein the security policy comprises a method of encoding the personal information, a method of protecting personal information including a digital signature, and/or information on an integrity attestation with respect to a platform of the apparatus.

26. The apparatus as claimed in claim 18, wherein the apparatus is based on a closed platform or employs technology for trusted computing, thereby enabling an integrity attestation of the platform, and the external device is based on an open platform and cannot perform the integrity attestation.

27. The apparatus as claimed in claim 18, wherein the personal information comprises the personal information of the user, additional information, and the service requesting identifier.

28. A method of transmitting personal information required by a service or product requested through an external device to a service provider, the method comprising:
receiving the personal information from a user;
transmitting a service requesting identifier to the service provider;
receiving a security policy with respect to the personal information to be transmitted;
securing the personal information to be transmitted according to the received security policy; and
transmitting the personal information to the service provider.

29. The method as claimed in claim 28, further comprising:
receiving a transmission approval from the user before the transmitting of the service requesting identifier.

30. The method as claimed in claim 28, further comprising:
receiving an information request message requesting the personal information.

31. The method as claimed in claim 28, wherein the securing of the personal information comprises:
measuring an integrity attestation with respect to a platform of a device that transmits the personal information; and
transmitting an attestation certificate obtained from the measuring of the integrity attestation.

32. The method as claimed in claim 28, wherein the receiving of the personal information comprises:
storing new personal information that has not previously been stored in a device that transmits the personal information.

33. The method as claimed in claim 28, wherein the receiving of the personal information comprises:
receiving selections of the personal information from among personal information stored in a device that transmits the personal information.

34. The method as claimed in claim 28, wherein the security policy comprises a method of encoding the personal information, a method of protecting personal information including a digital signature, and/or information on an integrity attestation with respect to a platform of a device that transmits the personal information.

35. The method as claimed in claim 28, wherein the personal information is stored in a predetermined device that transmits the information and is different from the external device.

36. The method as claimed in claim 35, wherein the predetermined device is based on a closed platform or employs technology for trusted computing, thereby enabling an integrity attestation of the platform, and the external device is based on an open platform and cannot perform the integrity attestation.

37. The method as claimed in claim 28, wherein the external device receives the information request, receives the personal information, transmits the service requesting identifier, receives the security policy, secures the personal information, and transmits the personal information.

38. The method as claimed in claim 28, wherein a predetermined device different from the external device receives the information request, receives the personal information, transmits the service requesting identifier, receives the security policy, secures the personal information, and transmits the personal information.

39. The method as claimed in claim 28, wherein the securing of the personal information comprises:
encoding the personal information according to the security policy.

40. A computer-readable recording medium encoded with the method of claim 28 and implemented by a computer.

41. An apparatus to transmit personal information required by a service or product requested by a user to a service provider, the apparatus comprising:
a user interface to receive inputs and selections of the personal information to be transmitted;
a security policy determination unit to transmit a service requesting identifier to the service provider and to receive a security policy for the personal information to be transmitted; and
an encoding unit to secure the personal information to be transmitted according to the received security policy and to transmit the secured personal information to the service provider.

42. The apparatus as claimed in claim 41, wherein the encoding unit secures the personal information by encoding the personal information according to the received security policy.

43. The apparatus as claimed in claim 41, further comprising:
a personal information storage unit to store personal information of the user,
wherein the user interface receives the selections of the personal information to be transmitted from among the personal information stored in the personal information storage unit.

44. The apparatus as claimed in claim 43, wherein the personal information storage unit stores new personal information that has not previously been stored.

45. The apparatus as claimed in claim 41, wherein the user interface displays an information request message requesting the personal information to be transmitted.

46. The apparatus as claimed in claim 41, further comprising:
an integrity measurement unit to measure an integrity attestation with respect to a platform of the apparatus and to transmit an attestation certificate with respect to the integrity attestation to the service provider.

47. The apparatus as claimed in claim 41, wherein the security policy comprises a method of encoding the personal information, a method of protecting personal information including a digital signature, and/or information on an integrity attestation with respect to a platform of the apparatus.

48. The apparatus as claimed in claim 41, wherein:
the service or the product is requested by the user in an external device, separate from the apparatus, that is based on an open platform and cannot perform an integrity attestation; and
the apparatus is based on a closed platform or employs technology for trusted computing, thereby enabling the integrity attestation of the platform.

49. The apparatus as claimed in claim 48, wherein the apparatus is a portable device and the external device is a stationary device.

50. A method of transmitting personal information required by a requested service or product from a device to a service provider, the method comprising:
receiving the personal information, from a user, at the device;
transmitting a service requesting identifier to the service provider;
confirming, at the service provider, that the service requesting identifier corresponds to the requested service or product provided by the service provider;
transmitting a security policy with respect to the personal information to be transmitted from the service provider to the device;
securing, at the device, the personal information to be transmitted according to the security policy; and
transmitting the personal information from the device to the service provider.

51. The method as claimed in claim 50, further comprising:
transmitting an information request message requesting the personal information from the service provider to the device.

52. The method as claimed in claim 50, wherein the securing of the personal information comprises:
measuring an integrity attestation with respect to a platform of the device; and
transmitting an attestation certificate obtained from the measuring of the integrity attestation.

53. The method as claimed in claim 50, wherein the security policy comprises a method of encoding the personal information, a method of protecting the personal information including a digital signature, and/or information on an integrity attestation with respect to a platform of the device.

54. The method as claimed in claim 50, wherein the securing of the personal information comprises:
encoding the personal information according to the security policy.

55. A computer-readable recording medium encoded with the method of claim 50 and implemented by a computer.
